(19) United States
(12) Patent Application Publication
(10) Pub. No.: US 2024/0069921 A1
(43) Pub. Date: Feb. 29, 2024

(54) DYNAMICALLY RECONFIGURABLE PROCESSING CORE

(71) Applicant: Intel Corporation, Santa Clara, CA (US)

(72) Inventors: Scott Cline, Portland, OR (US); Robert Pawlowski, Beaverton, OR (US); Joshua Fryman, Corvallis, OR (US); Ivan Ganev, Portland, OR (US); Vincent Cave, Hillsboro, OR (US); Sebastian Szkoda, Gdansk (PL); Fabio Checconi, Fremont, CA (US)

(21) Appl. No.: 18/477,884

(22) Filed: Sep. 29, 2023

(51) Int. Cl. G06F 9/38; G06F 9/30

(52) U.S. Cl. CPC G06F 9/3885; G06F 9/30036

(57) ABSTRACT

Technology described herein provides a dynamically reconfigurable processing core. The technology includes a plurality of pipelines comprising a core, where the core is reconfigurable into one of a plurality of core modes, a core network to provide inter-pipeline connections for the pipelines, and logic to receive a morph instruction including a target core mode from an application running on the core, determine a present core state for the core, and morph, based on the present core state, the core to the target core mode. In embodiments, to morph the core, the logic is to select, based on the target core mode, which inter-pipeline connections are active, where each pipeline includes at least one multiplexor via which the inter-pipeline connections are selected to be active. In embodiments, to morph the core, the logic is further to select, based on the target core mode, which memory access paths are active.

### GOVERNMENT INTEREST STATEMENT

This invention was made with government support under contract No. W911NF-22-C-0081 awarded by the Army Research Office and the Intelligence Advanced Research Projects Activity (IARPA). The government has certain rights in the invention.

### BACKGROUND

Emerging software applications are trending towards increasing needs of mixed-mode computing consisting of some combination of hyper-sparse graph analytics, dense artificial intelligence (AI) tasks, and typical single-thread serial work. All of these workload types have different compute requirements, and currently there are only widely different architectural approaches for handling each of these workload types. Traditional approaches to mixed-mode computing require copying data between compute types e.g., between a central processing unit (CPU) and a graphics processing unit (GPU)—and task-level parallelism that distributes work over a heterogeneous architecture. Such approaches, however, face fundamental efficiency and performance limitations due to excessive data movement, which also limits scalability.

### BRIEF DESCRIPTION OF THE DRAWINGS

The various advantages of the embodiments will become apparent to one skilled in the art by reading the following specification and appended claims, and by referencing the following drawings, in which:

FIG. 1A provides a block diagram illustrating an example of a socket using a plurality of compute tiles according to one or more embodiments;

FIG. 1B provides a block diagram illustrating an example computing system according to one or more embodiments;

FIG. 2 provides a block diagram illustrating an example of a slice in a compute tile according to one or more embodiments;

FIG. 3 provides a block diagram illustrating an example of a compute tile with a reconfigurable core according to one or more embodiments;

FIG. 4A provides a block diagram illustrating an example of an amorphous core engine for use in a reconfigurable core according to one or more embodiments;

FIG. 4B provides a block diagram illustrating aspects of an example of a pipeline in a reconfigurable core according to one or more embodiments;

FIGS. 5A-5D provide diagrams illustrating examples of core modes for a reconfigurable core according to one or more embodiments;

FIG. 6 provides a flow diagram illustrating an example method of morphing a reconfigurable core according to one or more embodiments;

FIG. 7 provides a flow diagram illustrating an example method of operating a computing system having a reconfigurable core according to one or more embodiments;

FIG. 8 provides a block diagram illustrating an example performance-enhanced computing system according to one or more embodiments;

FIG. 9 provides a block diagram illustrating an example semiconductor apparatus for a reconfigurable core according to one or more embodiments;

FIG. 10 is a block diagram illustrating an example processor core according to one or more embodiments; and

FIG. 11 is a block diagram illustrating an example of a multi-processor based computing system according to one or more embodiments.

### DESCRIPTION OF EMBODIMENTS

Improved processing technology as described herein provides a hardware architecture that efficiently mirrors dynamic mode switching with limited excess data movement across a computing system. The architecture is based on dynamically reconfigurable processing cores that support a variety of compute modes, including modes for use in sparse and dense computing applications. The improved technology eliminates costly data transfers between different specialized hardware units, providing high performance and efficiency in mixed-mode sparse and dense computing applications while enabling scalability.

Embodiments as described herein provide a dynamically reconfigurable processing core that supports multiple compute modes, including: (1) a multiple instruction multiple data (MIMD) mode for handling sparse data tasks (such as, for example, sparse graph analytics); (2) a tensor mode for handling dense compute AI tasks (such as, for example, general matrix multiplication and convolution tasks in neural networks); (3) a single instruction multiple data (SIMD) mode for handling vectorizable tasks (such as, for example, vector arithmetic tasks—e.g., C[i]=A[i]+B [i]); and/or (4) a scalar (e.g., superscalar) mode for handling single thread mode tasks (such as, for example, general processing tasks handled by a CPU prior to launching or offloading AI tasks requiring specialized handling). Because mixed-mode computing applications call upon most, if not all, of these types of processing tasks, the dynamically reconfigurable processing core as described herein is able to perform each of these tasks within a common application using the mode best suited for the type of task, without the need for inefficient data replication between different compute units or running applications on inefficient hardware units that are ill-suited to the task.

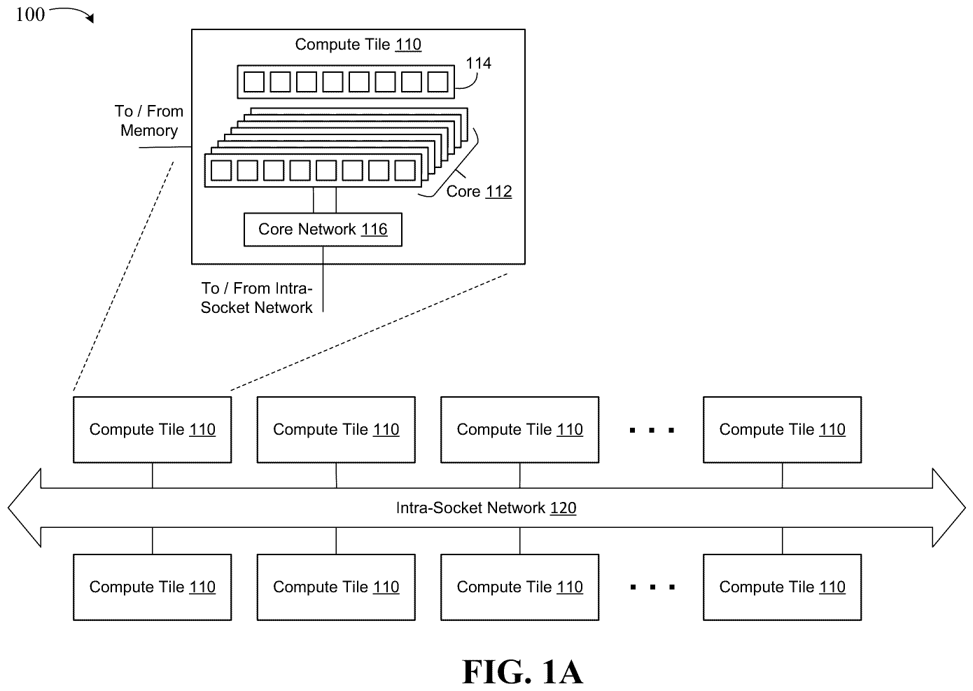

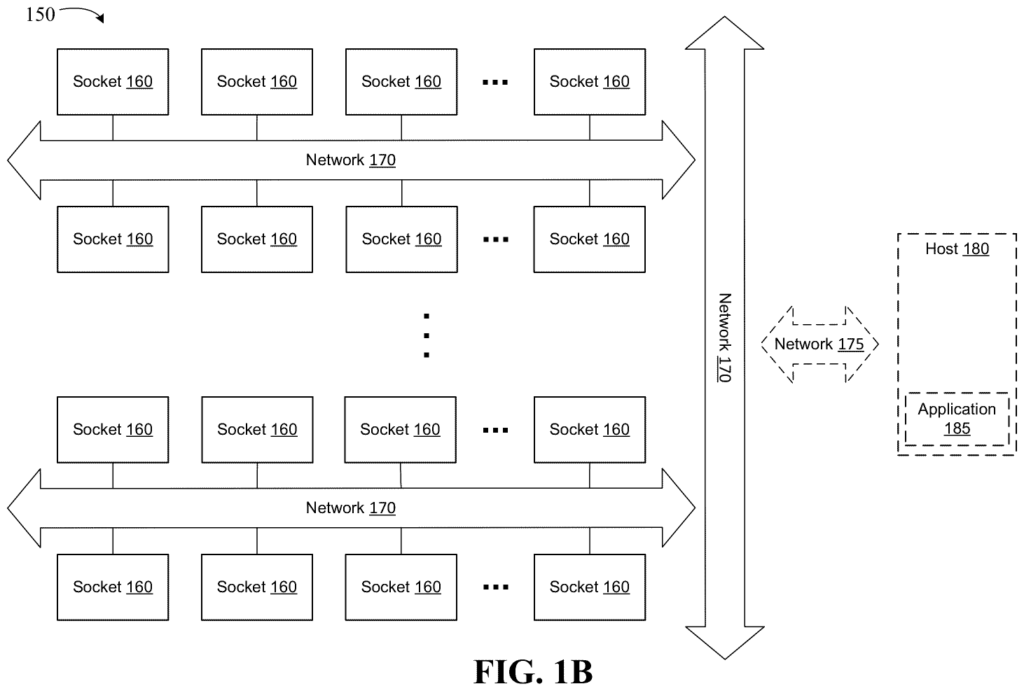

FIG. 1A provides a block diagram illustrating an example of a socket 100 according to one or more embodiments, with reference to components and features described herein including but not limited to the figures and associated description. As shown in FIG. 1, the socket 100 includes a plurality of compute tiles 110 and an intra-socket network 120. In some embodiments the socket 100 includes 16 compute tiles 110. In some embodiments, the socket 100 includes a number of compute tiles 110 that is greater than or less than 16. Each compute tile 110 includes a reconfigurable core 112, an execution slice 114 and a core network 116.

The reconfigurable core 112 includes a plurality of individual pipelines which, in certain modes, are configured into slices. As an example, in some embodiments the reconfigurable core 112 includes 64 pipelines, where in certain modes the pipelines are configured into a set of eight slices, where each slice includes eight pipelines. The pipelines support multiple hardware threads (e.g., 2, 4, 8, 16 etc. threads) and can be scalar in-order pipelines including instruction fetch, decode, execute (which has an integer arithmetic logic unit (ALU) and floating-point unit (FPU)), memory management and writeback stages. In some embodiments the reconfigurable core 112 includes a number of pipelines that is greater than or less than 64.

Thus, according to the example socket 100 illustrated in FIG. 1A, there is included a hierarchy of processing elements: a hardware pipeline (which can be a multi-threaded pipeline), a slice (which includes, e.g., eight pipelines), a compute tile (which includes a core having, e.g., eight slices), and a socket (which includes, e.g., 16 tiles). In addition, each compute tile 110 includes the execution slice 114, which is additional to the core slices and includes a plurality of pipelines (e.g. eight pipelines) configured into a slice. The execution slice 114 executes an operating system (e.g., Linux) for the compute tile 110, which manages overall tile operation—including, e.g., launching one or more applications to execute on the reconfigurable core. In embodiments the pipelines in the execution slice 114 include the same hardware structure as the pipelines in the reconfigurable core 112.

The core network 116 includes a network that provides coupling (e.g., connections for data communication) between the pipelines, which supports both wide (e.g., dense datapath) and narrow (e.g., sparse datapath) accesses. The core network 116 also provides a route for coupling between the compute tile 110 and the intra-socket network 120 (e.g., via one or more ports). The core network 116 includes any type of network connections suitable for data communications between and among the pipelines in the reconfigurable core 112.

Each compute tile 110 further includes one or more connections to provide data to and from system memory. For example, in some embodiments each pipeline in the reconfigurable core can be connected to system memory. As another example, in some embodiments certain pipelines in a slice can be connected to system memory. System memory can include double data rate (DDR) memory, dynamic random access memory (DRAM), etc. Each socket has its own system memory. Each compute tile 110 also has internal memory such as data cache, instruction cache and/or scratchpad SRAM (not shown in FIG. 1A).

The intra-socket network 120 provides a network to couple (e.g., connections for data communication) together the plurality of compute tiles 110. The intra-socket network 120 includes any type of network connections suitable for data communications between and among the plurality of compute tiles 110.

Some or all components and/or features in the socket 100 can be implemented using one or more of a central processing unit (CPU), a graphics processing unit (GPU), a reduced instruction set computer (RISC) processor, an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the socket 100 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the socket 100 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, instruction set architecture (ISA) instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 1B provides a block diagram illustrating an example computing system 150 according to one or more embodiments, with reference to components and features described herein including but not limited to the figures and associated description. The system 150 includes a plurality of sockets 160 and a network 170. In embodiments each socket 160 corresponds to the socket 100 (FIG. 1A, already discussed). In embodiments the system 150 can include tens of sockets 160, hundreds of sockets 160, thousands of sockets 160, tens of thousands of sockets 160, hundreds of thousands of sockets 160, etc., thus providing for a high degree of scalability for the computing system 150. As such, the computing system 150 can support, e.g., workflows that include both dense and sparse (graph) algorithmic tendencies on large datasets that can extend up to or even beyond 10 peta bytes (PB).

The network 170 provides a network to couple (e.g., connections for data communication) together the plurality of sockets 160. In some embodiments, the network 170 includes an optical network. In some embodiments the network 170 is organized into a polar star network configuration. In embodiments the network 170 includes any other type of network connections suitable for data communications between and among the plurality of sockets 160.

In some embodiments, the system 150 also includes a host processor 180. The host processor 180 can include a CPU, GPU, RISC processor, etc. The host processor 180 operates to coordinate tasks performed by the plurality of sockets 160. For example, the host processor 180 serves to distribute an application 185 to the plurality of sockets 160 (or a subset thereof) to be executed, to load data to the plurality of sockets 160 (or instruct the sockets 160 to fetch data), to instruct the sockets 160 to execute the application 185 to perform compute tasks, and/or to collect task results. In some embodiments, the host processor 180 is coupled directly to the network 170. In some embodiments, the host processor 180 is coupled to the network 170 via a network 175 suitable for connecting the host processor 180 to the network 170.

Some or all components and/or features in the system 150 can be implemented using one or more of a CPU, a GPU, a RISC processor, an AI accelerator, an FPGA accelerator, an ASIC, and/or via a processor with software, or in a combination of a processor with software and an FPGA or ASIC. More particularly, components of the system 150 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 150 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

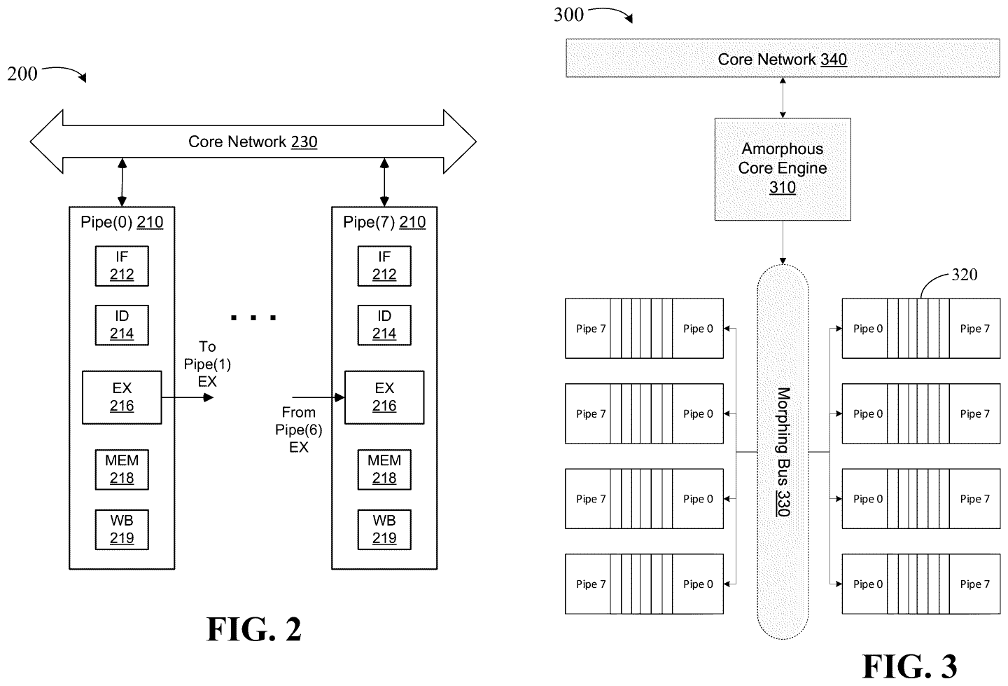

FIG. 2 provides a block diagram illustrating an example of a slice 200 in a compute tile (such as, e.g., the compute tile 110 in FIG. 1A, already discussed) according to one or more embodiments, with reference to components and features described herein including but not limited to the figures and associated description. The slice 200 includes a plurality of pipelines 210, where each pipeline is coupled to a core network 230. The core network 230 provides coupling (e.g., data communications) between pipelines in the slice 200 and between slices within a compute tile, and in embodiments the core network 230 corresponds to the core network 116 (FIG. 1A, already discussed). In the example shown in FIG. 2, the slice 200 includes eight pipelines 210 (e.g., labeled as Pipe(0) . . . Pipe(7)). In embodiments, a number of slices 200 (such as, e.g., eight slices) are coupled to form a reconfigurable core (such as, e.g., the reconfigurable core 112 in FIG. 1A, already discussed). In embodiments, an additional slice 200 forms an execution slice (e.g., the execution slice 114 in FIG. 1A, already discussed). In some embodiments, a slice 200 can include greater than or less than eight pipelines.

Each pipeline 210 includes several stages such as an instruction fetch (IF) stage 212, an instruction decode (ID) stage 214, an execution (EX) stage 216, a memory (MEM) stage 218, and a writeback (WB) stage 219. Each pipeline 210 also includes an instruction cache and a data cache (not shown in FIG. 2). The IF stage 212 performs an instruction fetch (e.g., from the instruction cache) and translates a program counter (e.g., from virtual to physical). The ID stage 214 decodes the instruction, setting various pipeline control signals and reading register file operands. The EX stage 216 executes the instruction (which can include integer or floating-point operations, etc.). The MEM stage 218 translates a load/store/atomic address from virtual to physical and sends data to data cache or memory. The WB stage 219 retires the instruction in program order, writing the register file.

In certain compute modes, the EX stage 216 of each pipeline is configured to “feed forward” its output to the next pipeline in the slice. For example, the EX output from Pipe(0) is fed as an EX input to Pipe(1), the EX output from Pipe(1) is fed as an EX input to Pipe(2), and so on to the end of the slice 200 where the EX output from Pipe(6) is fed as an EX input to Pipe(7). The EX stage 216 of Pipe 0 (first pipeline in the slice 200 in the example shown in FIG. 2) can receive data input (e.g., from another slice), and the output of the EX stage 216 of Pipe 7 (last pipeline in the slice 200 in the example shown in FIG. 2) can be stored or provided to another slice.

Some or all components and/or features in the slice 200 can be implemented using one or more of a CPU, a GPU, a RISC processor, an AI accelerator, an FPGA accelerator, an ASIC, and/or via a processor with software, or in a combination of a processor with software and an FPGA or ASIC. More particularly, components of the slice 200 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the slice 200 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 3 provides a block diagram illustrating an example of a compute tile 300 with a reconfigurable core according to one or more embodiments, with reference to components and features described herein including but not limited to the figures and associated description. In embodiments the compute tile corresponds to the compute tile 110 (FIG. 1A, already discussed). As illustrated in FIG. 3, the compute tile 300 includes an amorphous core engine 310, a plurality of slices 320, and a morphing bus 330. The amorphous core engine 310, the plurality of slices 320, and the morphing bus 330 collectively form a reconfigurable core, where the reconfigurable core corresponds to the reconfigurable core 112 in FIG. 1A (already discussed).

Mode switching (morphing between compute modes) on the reconfigurable core is controlled by the application running on the reconfigurable core, which issues instructions (e.g., morph instructions) regarding mode switching to the amorphous core engine 310. The application determines when to switch modes in the reconfigurable core and what mode to switch to.

When an application is first launched on the reconfigurable core, it begins execution in the default mode (e.g., superscalar mode), which operates a single hardware thread. Once the application reaches a point in execution where it is advantageous to switch modes (e.g., morph to MIMD mode to have parallel execution of a code segment), the application issues the morph instruction with the appropriate mode encoding. In the case of a morph to MIMD mode, each pipeline in the core will receive the program counter (PC) in which to begin execution, as well as a stack pointer (SP), and begins execution. Once the MIMD code segment is done, the thread issues an unmorph instruction (described further herein) as an indication that it has completed the code segment. Once all hardware threads of the mode have issued the unmorph instruction, the core returns (i.e., is switched or morphed) to the default (e.g., superscalar) mode.

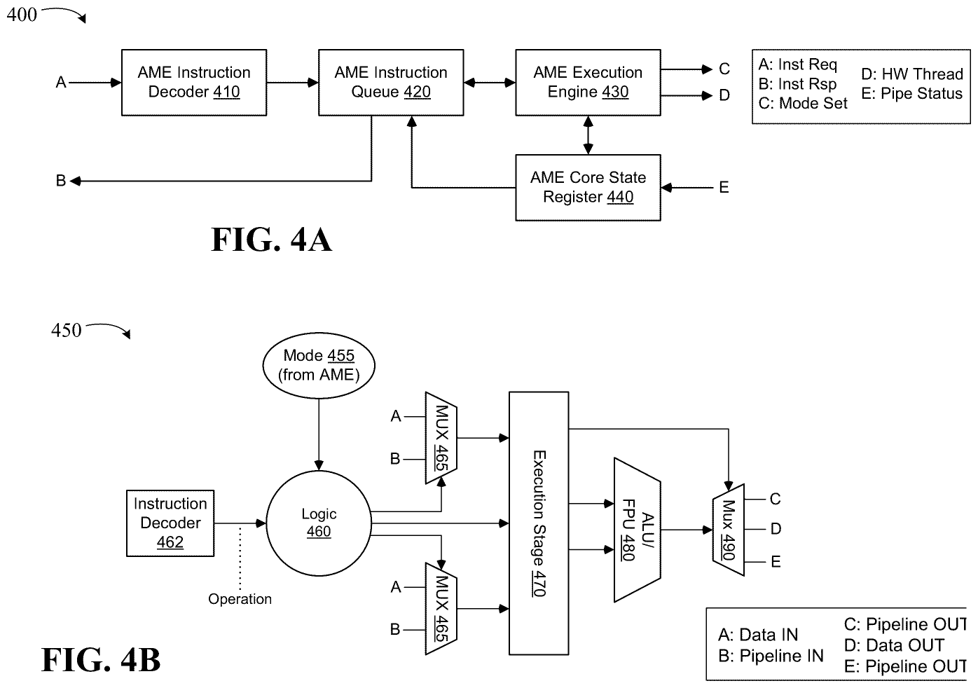

The amorphous core engine 310 handles morphing (switching) of the core mode from one mode to another mode, based on instructions from the application running on the reconfigurable core. The amorphous core engine 310 executes morphing instructions as well as synchronizing the pipelines for any mode switching operation. For example, when an application issues a morph instruction (e.g., via an executing hardware thread on the core), the morph instruction is delivered to the amorphous core engine 310 via the core network 340. The amorphous core engine 310 will decode the morph instruction and signal all the pipelines via the morphing bus 330. At this point all hardware threads for the mode begin execution. When a hardware thread issues the unmorph instruction, the hardware thread will signal the amorphous core engine 310 when that thread is quiesced (all pending instructions retired); once all threads on the core are quiesced, the amorphous core engine 310 returns the core to the default (e.g., superscalar) mode. Further details regarding the amorphous core engine 310 are provided herein with reference to FIG. 4A.

Each of the slices 320 includes a plurality of pipelines (as described above, the pipelines in the plurality of slices 320 along with the amorphous core engine 310 and the morphing bus 330 collectively form a reconfigurable core of the compute tile 300). In the example illustrated in FIG. 3, there are eight slices 320, where each slice 320 includes eight pipelines (providing a total of 64 pipelines for the reconfigurable core). In embodiments, each slice 320 corresponds to the slice 200 (FIG. 2, already discussed. In some embodiments, the reconfigurable core includes greater than or less than eight slices 320. In some embodiments, each slice 320 includes greater than or less than eight pipelines.

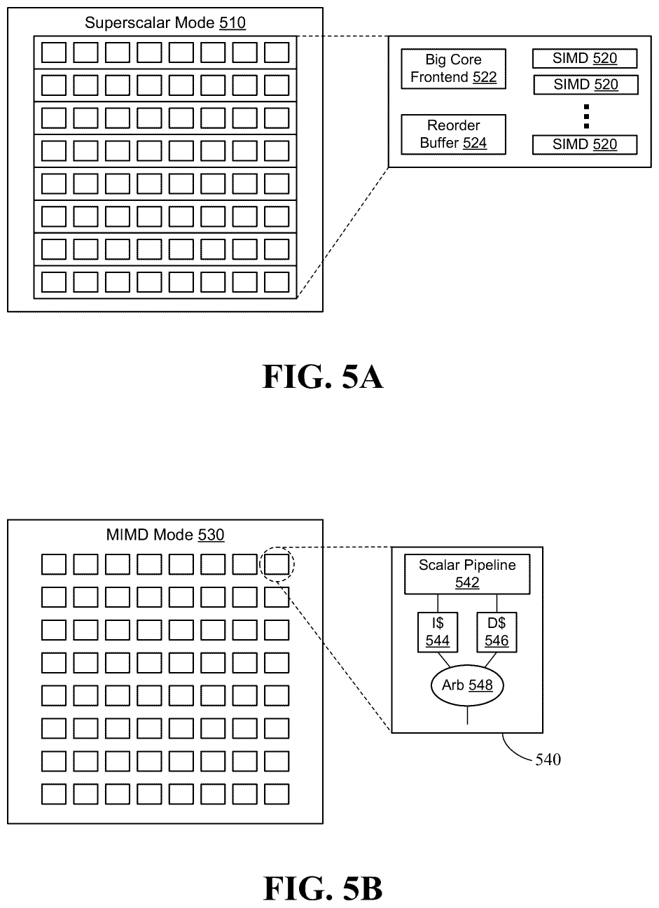

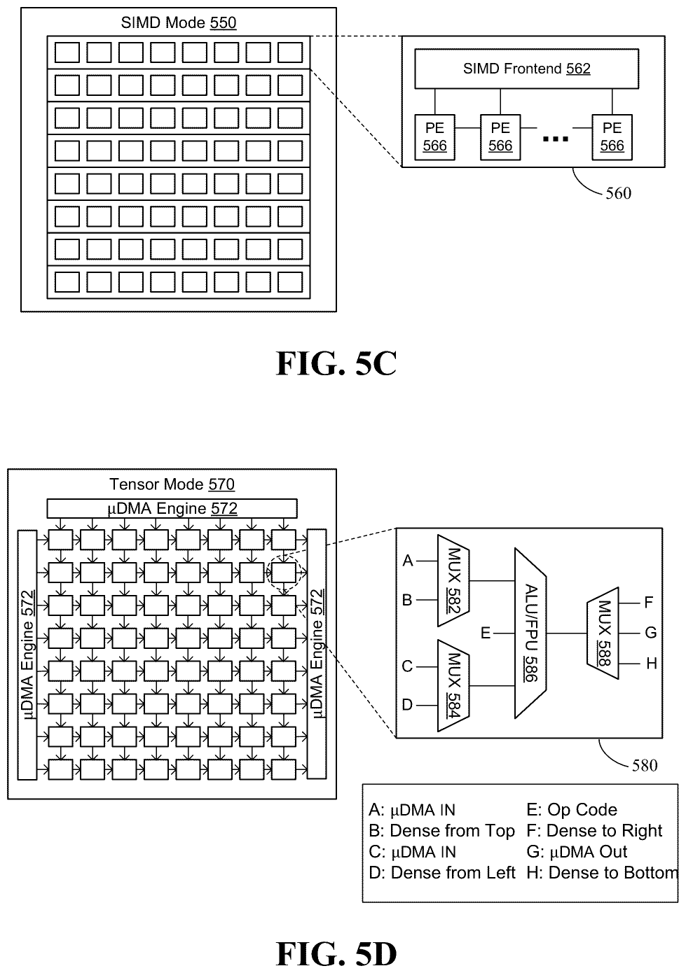

The morphing bus 330 directly connects the amorphous core engine 310 to all pipelines in the reconfigurable core, providing connectivity between the amorphous core engine 310 and certain logic/switching points in each pipeline to enable the amorphous core engine 310 to control morphing of the reconfigurable core. For example, via the morphing bus 330, the amorphous core engine 310 will broadcast to each pipeline an indicator that a morphing is taking place and new program counters (PC) and stack pointers (SP), and set the mode selector bits that drive which logic and multiplexor selects are used for the given mode. In embodiments, the morphing bus 330 includes a 64-bit databus along with control signals, where individual lines are connected to each pipeline. Further details regarding morphing are provided herein with reference to FIGS. 4A-4B and 5A-5D.

The compute tile 300 also includes the core network 340 providing coupling (e.g., data communications) between pipelines in the core. In embodiments the core network 340 corresponds to the core network 116 (FIG. 1A) and/or the core network 230 (FIG. 2), already discussed.

Some or all components and/or features in the compute tile 300 can be implemented using one or more of a CPU, a GPU, a RISC processor, an AI accelerator, an FPGA accelerator, an ASIC, and/or via a processor with software, or in a combination of a processor with software and an FPGA or ASIC. More particularly, components of the compute tile 300 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the compute tile 300 can be written in any combination of one or more programming languages, including an object-oriented programming language such as Java, JavaScript, Python, C #, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4A provides a block diagram illustrating an example of an amorphous core engine (AME) 400 for use in a reconfigurable core according to one or more embodiments, with reference to components and features described herein including but not limited to the figures and associated description. In embodiments the amorphous core engine 400 corresponds to the amorphous core engine 310 (FIG. 3, already discussed). As illustrated in FIG. 4A, the amorphous core engine 400 includes an AME instruction decoder 410, an AME instruction queue 420, an AME execution engine 430, and an AME core state register 440. The AME 400 receives instruction requests (label A in FIG. 4A), which are provided to the AME instruction decoder 410. The AME instruction decoder 410 decodes what instruction the AME received (e.g., a morph instruction, a context instruction, etc.) and forwards to the AME instruction queue 420.

Control of the transition of compute modes in the reconfigurable core is exposed to the application programmer via a morphing instruction set. The instructions can be provided, e.g., as a custom extension to the RISC-V ISA. Examples of instructions in the instruction set handled by the amorphous core engine 400 are provided in Table 1 and the description following:

TABLE 1

| Instruction: | Arguments: | Function: |
|---|---|---|
| Morph | mode, PC, SP | morph core into specified mode |
| Unmorph | | return core to default mode |
| Mode | <mode> | returns current core mode |
| Mode.Status | <bitmask> | returns state of each HW thread |
| Context.Id | status, pointer, | load pipeline context from memory |
| | target thread | |
| Context.St | status, pointer, | store pipeline context in memory |
| | target thread | |

Morph: the morph instruction is typically issued to the AME 400 while in a default mode. In embodiments the default mode corresponds to the superscalar mode. The Morph instruction identifies the target mode that the core is to be reconfigured in, and provides the AME 400 with a program counter (PC) to morph to and a stack pointer (SP) to morph with. The AME 400 will then broadcast the new PC and SP to all hardware threads on the core (except for tensor mode, which does not execute the normal instruction set), and set mode bits used by the rest of the core which selects which logic and datapaths are used.

Unmorph: the Unmorph instruction is issued by each hardware thread at the end of a special mode code segment (e.g., MIMD, SIMD, implicit for tensor). Once all active hardware threads are quiesced after issuing an unmorph instruction, the AME 400 returns the reconfigurable core to the default mode.

Mode: in response to the Mode instruction, the AME 400 returns a code indicating which mode the core is currently configured in.

Mode.Status: in response to the Mode.Status instruction, the AME 400 returns a status bitmask indicating which hardware threads in the compute tile are still active. For example, a “1” for a particular hardware thread indicates that the thread is still active (e.g., running), and a “0” for a particular hardware thread indicates that the thread is inactive (e.g., not running, and/or has issued an Unmorph instruction). The Mode.Status instruction can be used, e.g., as a debug tool to identify any long running or wedged hardware threads for the given mode.

Context.Id: the Context.Id instruction is used to pre-load a full hardware thread context to one or more given pipeline(s) before a mode transition. For example, this will pre-load an entire register file and control/status register (CSR) state before a mode switch, if just a PC and SP are insufficient for software needs. The context is loaded onto the pipeline(s) from memory.

Context.St: the Context.St instruction is used to save (store) an entire hardware thread's context to memory. It is essentially the reverse action of the Context.Id (load) action.

The AME instruction queue 420 allocates the received instruction into a queue for execution. Once execution is complete, the AME instruction queue 420 will send a response (label B in FIG. 4A), to whichever entity (i.e. a hardware thread) sent the instruction.

The AME execution engine 430 is a state machine which has behavior depending on which instruction it is currently executing. As one example, for a Morph instruction, AME execution engine 430 (a) determines whether the core is presently in a valid state (e.g., the default mode, which in embodiments is the superscalar mode) for morphing into the target mode (e.g., one of the SIMD mode, the MIMD mode, or the tensor mode); (b) sets mode bits for the reconfigurable core to effect which logic and muxing in the reconfigurable core is to become active (label C in FIG. 4A)—this is what drives the mode switch to the new target mode; and (c) sends a new PC and SP (e.g., via the morphing bus 330) to each new hardware thread that will be spawned from the morph to the target mode (label D in FIG. 4A). As another example, for a Context instruction (i.e., Context.Id or Context.St), the AME execution engine 430 sends a request to the target hardware thread(s) to load or save a hardware context from/to memory (label D in FIG. 4A). As another example, for an Unmorph instruction AME execution engine 430 checks for active hardware threads, and once all active hardware threads are quiesced the AME execution engine 430 sets mode bits for the reconfigurable core to return the core to the default mode.

The AME core state register 440 is a bank of registers that capture/keep track of various state(s) of the reconfigurable core. For example, AME core state register 440 tracks the current mode that the reconfigurable core is presently operating in—e.g., the current mode can be provided by the AME execution engine 430, and tracks the state of the hardware threads—e.g., which threads are active and which are inactive for the current mode (label E in FIG. 4A), etc. By reading the AME core state register 440, the AME execution engine 430 is able to determine the present core state of the reconfigurable core.

Some or all components and/or features in the amorphous core engine 400 can be implemented using one or more of a CPU, a GPU, a RISC processor, an AI accelerator, an FPGA accelerator, an ASIC, and/or via a processor with software, or in a combination of a processor with software and an FPGA or ASIC. More particularly, components of the amorphous core engine 400 can be implemented in one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the amorphous core engine 400 can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIG. 4B provides a block diagram illustrating aspects of an example of a pipeline 450 in a reconfigurable core according to one or more embodiments, with reference to components and features described herein including but not limited to the figures and associated description. In embodiments the pipeline 450 corresponds to any of the pipelines in the slice 200 (FIG. 2) and/or any of the pipelines in the compute tile 300 (FIG. 3), already discussed. The pipeline 450 includes logic 460, an instruction decoder 462, one or more input multiplexors 465, an execution stage 470, an arithmetic logic unit/floating point logic unit (ALU/FPU) 480, and an output multiplexor 490. The pipeline 450 receives mode select input 455 (e.g., mode select bits) from the amorphous core engine (e.g., the AME 400 in FIG. 4A). The mode select input is provided through connections via a morphing bus such as, e.g., the morphing bus 330 (FIG. 3, already discussed). The logic 460 operates, based on the mode select input 455 and the current instruction from the instruction decoder 462, to set the input multiplexor(s) 465 to select one of a set of inputs. For example, the inputs to the multiplexor(s) 465 can include data input (label A in FIG. 4B) which is provided from memory (e.g., cache memory or system memory), and/or a pipeline input (label B in FIG. 4B). The data input can be provided via direct memory access (DMA) such as, e.g., a micro-DMA engine (not shown in FIG. 4B) that is part of the core. The pipeline input can be provided from an output of an execution stage of another pipeline. Multiplexor selections for inter-pipeline connections can vary based on the instruction. As one example, in SIMD mode a basic vector integer add operation will result in no inter-pipeline muxing. As another example, in SIMD mode a vector rotate instruction will result in inter-pipeline muxing.

The output(s) of the multiplexor(s) 465 are provided to the execution stage 470. The current instruction from the instruction decoder 462 also passes through to the execution stage 470. The execution stage 470 includes logic that, for example, provides control signals and operands to the ALU/FPU 480 for performing arithmetic operation(s). While the ALU/FPU 480 is shown as a single element, it will be understood that the ALU/FPU 480 typically includes two distinct units, an ALU and a FPU which can include two distinct outputs. The output of the ALU/FPU 480 (e.g., which can include each of the ALU and FPU outputs) is provided to the output multiplexor 490, which routes the output to data output (label D in FIG. 4B) and/or one or two pipeline outputs (labels C, E in FIG. 4B). The data output is provided to memory (e.g., cache memory or system memory), and can be provided via DMA such as, e.g., a micro-DMA engine (not shown in FIG. 4B) that is part of the core. The pipeline output(s) can be provided as input(s) to one or more other pipeline(s) (e.g., via an input multiplexor in the respective pipeline).

FIGS. 5A-5D provide diagrams illustrating examples of core modes for a reconfigurable core according to one or more embodiments, with reference to components and features described herein including but not limited to the figures and associated description. Each of the example core modes as illustrated in FIGS. 5A-5D employs a reconfigurable core having 64 pipelines arranged according to the particular mode; the reconfigurable core can, in some embodiments, include greater than or less than 64 pipelines. In embodiments, the reconfigurable core that implements the subject core modes illustrated in FIGS. 5A-5D corresponds to the reconfigurable core 112 (FIG. 1A) and/or the reconfigurable core in the compute tile 300 (FIG. 3), already discussed.

Turning to FIG. 5A, shown is an example of a superscalar core mode 510. In the superscalar core mode 510, the entire reconfigurable core executes as a single hardware thread. The 64 pipelines are configured into SIMD slices 520 (e.g., 8 pipelines per slice), where each pipeline can be considered as operating as a single bit. Each slice 520 is seen as a SIMD “way”, resulting in an 8-wide superscalar SIMD thread. This takes advantage of Instruction Level Parallelism (ILP) to provide the highest single threaded performance. The core includes separate front-end logic (big core frontend 522 and reorder buffer 524) to provide, in the superscalar core mode 510, a wide instruction fetch and decode, as well as instruction issue logic to feed instructions from a single thread to the various compute slices across the core. In embodiments the superscalar core mode 510 is the default mode, meaning any mode switch to MIMD mode, SIMD mode, or tensor mode is initiated from the superscalar mode.

Turning now to FIG. 5B, shown is an example of a MIMD core mode 530. In the MIMD core mode 530, the pipelines operate effectively independently, where each of the independent processing elements 540 consists of a pipeline (e.g., scalar pipeline 542) with caches (e.g., instruction cache 544 and data cache 546), arbitrator 548, registers, etc. The MIMD core mode 530 provides a configuration which maximizes the number of hardware threads for a compute tile—e.g., each pipeline is a separate hardware thread. This enables high performance for sparse computation, where each thread has memory accesses that exhibit little spatial or temporal locality. In this configuration, each of the 64 pipelines in the reconfigurable core runs its own hardware thread, each pipeline has a full complement of CSRs and register files (e.g., as defined by the hardware environment, such as RISC-V), and each pipeline has its own instruction fetch, decode, execute, memory, and write back stages. The hardware threads can run the same or different instructions. The MIMD core mode 530 enables each thread to issue many load/store operations, such that, in aggregate, they are able to approach saturation of the memory bandwidth with these sparse requests.

Turning now to FIG. 5C, shown is an example of a SIMD core mode 550. For the SIMD core mode 550, all eight pipelines within each single slice are effectively concatenated together, providing a vector register width of 512-bits (64-bits per pipeline times eight pipelines). Each slice 560 includes a SIMD frontend 562 and eight pipelines (processing elements) 566, and runs a single hardware thread. In total, in SIMD core mode 550 the reconfigurable core has eight concurrent SIMD hardware threads, where each thread has a 64-bit integer, 64-bit floating point, and 512-bit vector register files. The SIMD core mode 550 reuses most resources present for the MIMD core mode 530 but, as configured, the SIMD core mode 550 enables improved performance/watt versus MIMD mode for vectorizable code. The first pipeline in the slice is responsible for fetching and retiring instructions, and any vector instructions are broadcast to all pipelines in the slice to execute the different vector lanes in parallel. Non-vector instructions are executed only by the first pipeline in the slice. The SIMD core mode 550 additionally includes optimizations for inter-lane functions including synchronizations, rotates, and shuffles.

Turning now to FIG. 5D, shown is an example of a tensor core mode 570. The tensor core mode 570 enables enhanced dense computation performance, especially for general matrix multiply (GEMM) and convolution operations. The tensor core mode 570 is unique in that it does not support a general hardware thread (i.e. in this mode the reconfigurable core does not execute all ISA instructions), but is instead utilized for executing certain operations such as GEMM and convolution operations using the ALU/FPU 586 to perform math operations.

The core includes three micro-DMA (uDMA) engines 572, which are each a dense memory access engine that uses a 64-byte wide datapath to read/write to memory. In the tensor core mode 570 mode, the uDMA engines 572 are responsible for reading matrix operands from memory and supplying it to the execution units in the pipelines, as well as writing the results of the execution to memory in bulk. These uDMA engines 572 also provide the configuration information to the dense array as the data flows through. Therefore, the array itself can be reconfigured on the fly to support the application's needs more efficiently. The functions within the uDMA engines 572 are exposed via a custom ISA and executed during a default (e.g. superscalar) one-thread mode.

As illustrated in FIG. 5D, for tensor core mode 570 the datapath of the ALU/FPU units of each pipeline are multiplexed together so that the result of one can quickly flow to the next pipeline for the next sequence in the computation. In embodiments the tensor core mode 570 also implements an accumulation tree at the output layer of the array in order to increase performance for the tensor operations. To enable the core to sustain peak throughput, the uDMA engine fetches the data directly from the local memory over a wide low-latency data bus. This is ideal for GEMM operations that do not require intermediate storage of values between tensor operations. For other operations like FFTs, a local SRAM (not shown in FIG. 5D) is provided for fast reading and writing via the uDMA engines. Each pipeline 580 performs an ALU/FPU operation based on the op code (label E in FIG. 5D).

In tensor core mode 570, the configuration for each pipeline 580 is set based in part on where in the array the pipeline is located. As illustrated in the example of FIG. 5D, for pipelines in the left-most column one input comes from a uDMA engine 572 and (except for the top pipeline in the column) another input comes from the pipeline situated above it. Thus for these pipelines one multiplexor 582 is set to select input B (dense from pipeline above) and the other multiplexor 584 is set to select input C (uDMA input). For the top pipeline in the left column the multiplexor 582 is set to select input A (uDMA input) and the other multiplexor 584 is set to select input C (uDMA input). For other pipelines in the top row, the multiplexor 582 is set to select input A (uDMA input) and the other multiplexor 584 is set to select input D (dense from pipeline to the left). For pipelines not in the top row or left-most column, the inputs are selected from neighbor pipelines: the multiplexor 582 is set to select input B (dense from the pipeline above) and the other multiplexor 584 is set to select input D (dense from the pipeline to the left). In embodiments, the multiplexor 582 and/or the multiplexor 584 correspond to one or more of the multiplexor(s) 465 (FIG. 4B, already discussed).

Pipeline outputs are similarly switched using the output multiplexor 588. For pipelines other than those in the right-most column or bottom row, the output multiplexor 588 is switched to provide the output F (dense to the pipeline to the right) and the output H (dense to the pipeline below). For pipelines in the right-most column (except bottom row), the output multiplexor 588 is switched to provide output G (uDMA output) and output H (dense to the pipeline below). For pipelines in the bottom row (except right-most column), the output multiplexor 588 is switched to provide the output F (dense to the pipeline to the right). Finally, for the pipeline in the right-most column, bottom row, the output multiplexor 588 is switched to provide output G (uDMA output). In embodiments, the output multiplexor 588 corresponds to the output multiplexor 490 (FIG. 4B, already discussed).

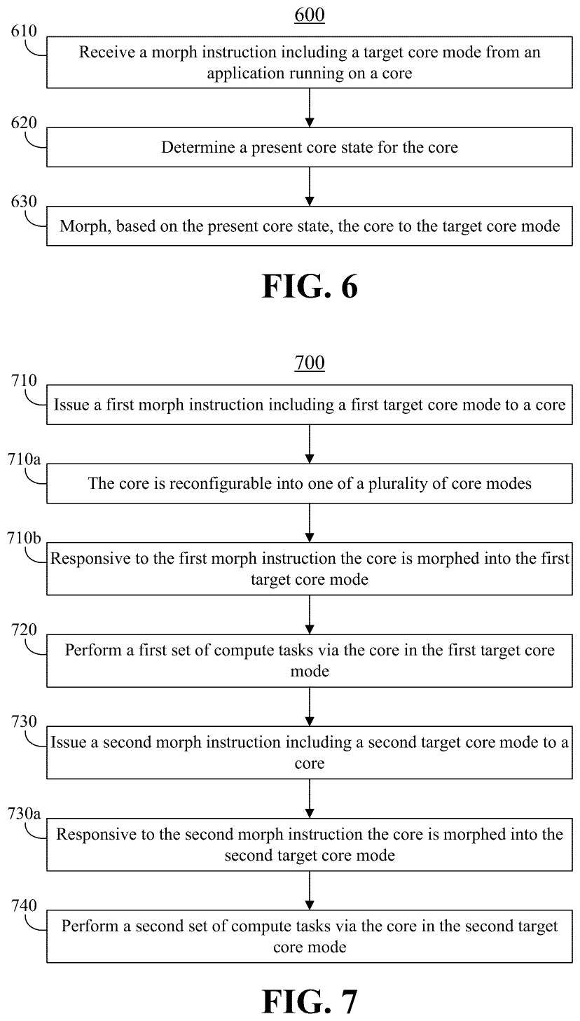

FIG. 6 provides a flow diagram illustrating an example method 600 of morphing a reconfigurable core according to one or more embodiments, with reference to components and features described herein including but not limited to the figures and associated description. The method 600 can generally be implemented in the compute tile 300 (FIG. 3, already discussed) and/or via components of the socket 100 (e.g., the reconfigurable core 112 in the compute tile 110) and/or the computing system 150 (FIGS. 1A-1B, already discussed). More particularly, the method 600 can be implemented as one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations for the method 600 and/or functions associated therewith can be written in any combination of one or more programming languages, including an object-oriented programming language such as Java, JavaScript, Python, C #, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 610 provides for receiving a morph instruction including a target core mode from an application running on a core. The core is comprised of a plurality of pipelines and is reconfigurable into one of a plurality of core modes. Illustrated processing block 620 provides for determining a present core state for the core. In some embodiments, the present core state (e.g., a current core mode, and an identification of currently active pipelines) is captured (e.g., tracked) by a core state register, and determining the present core state includes reading the core state register. Illustrated processing block 630 provides for morphing, based on the present core state, the core to the target core mode.

In some embodiments, morphing the core includes selecting, based on the target core mode, which inter-pipeline connections are active. In some embodiments, each pipeline of the plurality of pipelines includes at least one multiplexor via which one or more of the inter-pipeline connections are selected to be active. In some embodiments, a morphing bus is connected to each of the plurality of pipelines to provide mode select bits. In some embodiments, morphing the core further includes selecting, based on the target core mode, which memory access paths are active.

In some embodiments, the plurality of core modes include a default mode and one or more of a single instruction multiple data (SIMD) mode, a multiple instruction multiple data (MIMD) mode, or a tensor mode. In some embodiments, the default mode is a superscalar mode. In some embodiments, the present core state includes a current core mode and an identification of currently active pipelines, and morphing the core includes determining that the current core mode is the default mode, the target mode is a mode other than the default mode, and there are no currently active pipelines. In some embodiments, the method 600 further includes morphing the core to the default mode when all hardware threads for the current core mode have issued an unmorph instruction.

FIG. 7 provides a flow diagram illustrating an example method 700 of operating a computing system having a reconfigurable core according to one or more embodiments, with reference to components and features described herein including but not limited to the figures and associated description. The method 700 can generally be implemented in the socket 100 (FIG. 1A, already discussed) and/or the computing system 150 (FIG. 1B, already discussed). More particularly, the method 700 can be implemented as one or more modules as a set of program or logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations for the method 700 and/or functions associated therewith can be written in any combination of one or more programming languages, including an object-oriented programming language such as Java, JavaScript, Python, C#, C++, Perl, Smalltalk, or the like and conventional procedural programming languages, such as the “C” programming language or similar programming languages. Additionally, program or logic instructions might include assembler instructions, ISA instructions, RISC instructions (e.g., RISC-V ISA), machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 710 provides for issuing a first morph instruction including a first target core mode to a core, where at block 710a the core is reconfigurable into one of a plurality of core modes, and where at block 710b responsive to the first morph instruction the core is morphed into the first target core mode. Illustrated processing block 720 provides for performing a first set of compute tasks via the core in the first target core mode. Illustrated processing block 730 provides for issuing a second morph instruction including a second target core mode to the core, where at block 730a responsive to the second morph instruction the core is morphed into the second target core mode. Illustrated processing block 740 provides for performing a second set of compute tasks via the core in the second target core mode.

In some embodiments, the plurality of core modes include a default mode and one or more of a single instruction multiple data (SIMD) mode, a multiple instruction multiple data (MIMD) mode, or a tensor mode. In some embodiments, the first target core mode is the MIMD mode, and the first set of compute tasks include tasks directed to sparse data operations. In some embodiments, the first target core mode is the SIMD mode, and wherein the first set of compute tasks include vector operations. In some embodiments, the first target core mode is the tensor mode, and wherein the first set of compute tasks include one or more of matrix multiplication operations or convolution operations. In some embodiments, the core is morphed (e.g., returned) to the default mode after the first set of compute tasks is completed and before the core is morphed into the second core mode. In some embodiments, the method 700 includes issuing an unmorph instruction to morph the core to the default mode prior to issuing the second morph instruction.

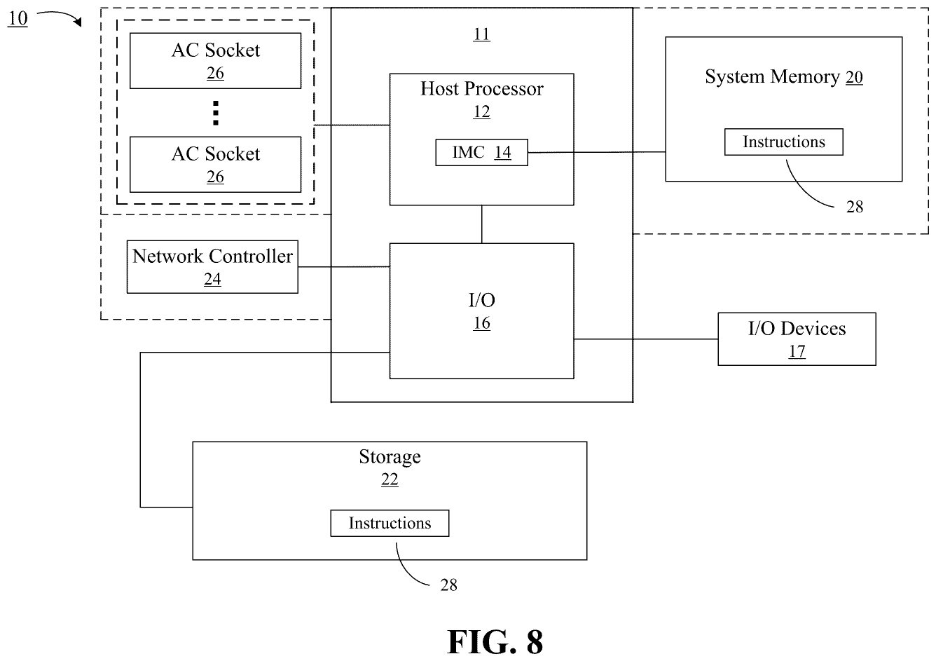

FIG. 8 shows a block diagram illustrating an example performance-enhanced computing system 10 for performing compute tasks via a reconfigurable core according to one or more embodiments, with reference to components and features described herein including but not limited to the figures and associated description. The system 10 can generally be part of an electronic device/platform having computing and/or communications functionality (e.g., a server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry, or other wearable devices), vehicular functionality (e.g., car, truck, motorcycle), robotic functionality (e.g., robot or autonomous robot), Internet of Things (IoT) functionality, etc., or any combination thereof. In the illustrated example, the system 10 can include a host processor 12 (e.g., central processing unit/CPU) having an integrated memory controller (IMC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) module 16. The I/O module 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/or the I/O module 16 can communicate with the storage 22 (all or portions thereof) via a network controller 24. The system 10 includes (or connects to) one or more sockets 26 (e.g., socket(s) corresponding to the socket 100 in FIG. 1A).

The host processor 12 and the I/O module 16 can be implemented together on a semiconductor die as a system on chip (SoC) 11, shown encased in a solid line. The SoC 11 can therefore operate as a computing apparatus for performing compute tasks via a reconfigurable core. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O module 16 can execute program instructions 28 retrieved from the system memory 20 and/or the storage 22 to perform one or more aspects of process 700 as described herein with reference to FIG. 7, already discussed. In some embodiments, the host processor 12 includes logic (e.g., configurable hardware, fixed-functionality hardware, etc., or any combination thereof) to implement one or more aspects of the method 600 (FIG. 6), already discussed. The system 10 can implement one or more aspects of the socket 100 and/or the system 150 as described herein with reference to FIGS. 1A-1B. The system 10 is therefore considered to be performance-enhanced at least to the extent that the technology provides the ability to perform mixed-mode compute applications in different core modes via a reconfigurable core.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touchscreen, keyboard, mouse, cursor-control device, microphone, digital camera, video recorder, camcorder, biometric scanners and/or sensors; input devices can be used to enter information and interact with system 10 and/or with other devices. The I/O devices 17 can also include one or more of output devices, such as a display (e.g., touchscreen, liquid crystal display/LCD, light emitting diode/LED display, plasma panels, etc.), speakers and/or other visual or audio output devices. The input and/or output devices can be used, e.g., to provide a user interface.

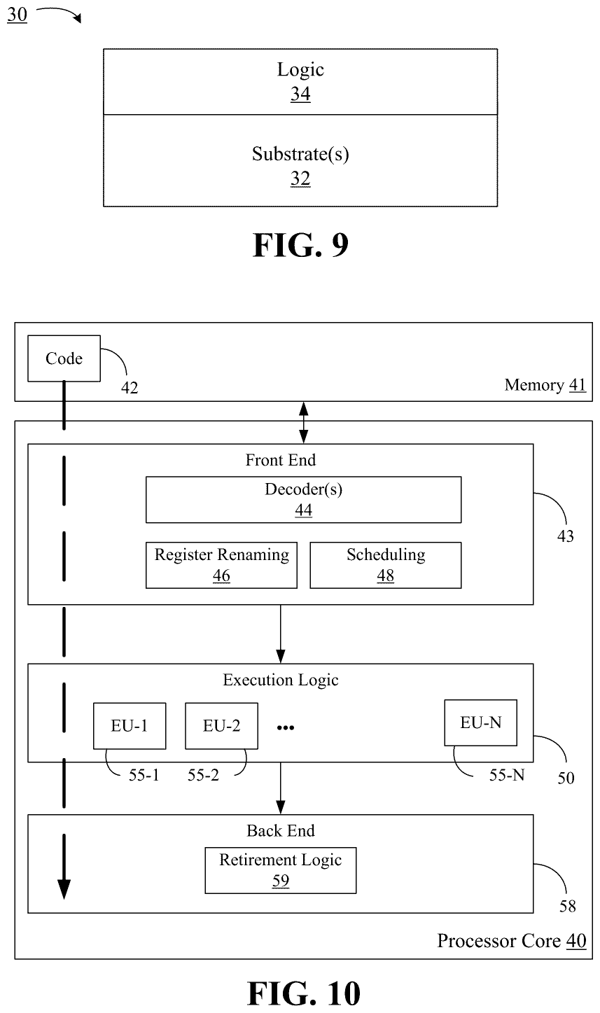

FIG. 9 shows a block diagram illustrating an example semiconductor apparatus 30 for performing compute tasks via a reconfigurable core according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 8. The logic 34 can implement one or more aspects of the processes described above, including the process 700 and/or the process 800. The logic 34 can implement one or more aspects of the socket 100, the compute tile 110, the reconfigurable core 112, the system 150, the slice 200, the compute tile 300, the amorphous core engine 400, and/or the pipeline 450 as described herein with reference to FIGS. 1A-1B, 2, 3, 4A-4B, and 5A-5D. The apparatus 30 is therefore considered to be performance-enhanced at least to the extent that the technology provides the ability to perform mixed-mode compute applications in different core modes via a reconfigurable core.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 34.

FIG. 10 is a block diagram illustrating an example processor core 40 according to one or more embodiments, with reference to components and features described herein including but not limited to the figures and associated description. The processor core 40 can be the core for any type of processor, such as a micro-processor, an embedded processor, a digital signal processor (DSP), a network processor, a graphics processing unit (GPU), or other device to execute code. Although only one processor core 40 is illustrated in FIG. 10, a processing element can alternatively include more than one of the processor core 40 illustrated in FIG. 10. The processor core 40 can be a single-threaded core or, for at least one embodiment, the processor core 40 can be multithreaded in that it can include more than one hardware thread context (or “logical processor”) per core.

FIG. 10 also illustrates a memory 41 coupled to the processor core 40. The memory 41 can be any of a wide variety of memories (including various layers of memory hierarchy) as are known or otherwise available to those of skill in the art. The memory 41 can include one or more code 42 instruction(s) to be executed by the processor core 40. The code 42 can implement one or more aspects of the processes 600 and/or 700 described above. The processor core 40 can implement one or more aspects of the socket 100, the system 150, the slice 200, the compute tile 300, the amorphous core engine 400, and/or the pipeline 450 as described herein with reference to FIGS. 1A-1B, 2, 3, 4A-4B, and 5A-5D. The processor core 40 can follow a program sequence of instructions indicated by the code 42. Each instruction can enter a front end portion 43 and be processed by one or more decoders 44. The decoder 44 can generate as its output a micro operation such as a fixed width micro operation in a predefined format, or can generate other instructions, microinstructions, or control signals which reflect the original code instruction. The illustrated front end portion 43 also includes register renaming logic 46 and scheduling logic 48, which generally allocate resources and queue the operation corresponding to the convert instruction for execution.

The processor core 40 is shown including execution logic 50 having a set of execution units 55-1 through 55-N. Some embodiments can include a number of execution units dedicated to specific functions or sets of functions. Other embodiments can include only one execution unit or one execution unit that can perform a particular function. The illustrated execution logic 50 performs the operations specified by code instructions.

After completion of execution of the operations specified by the code instructions, back end logic 58 retires the instructions of code 42. In one embodiment, the processor core 40 allows out of order execution but requires in order retirement of instructions. Retirement logic 59 can take a variety of forms as known to those of skill in the art (e.g., re-order buffers or the like). In this manner, the processor core 40 is transformed during execution of the code 42, at least in terms of the output generated by the decoder, the hardware registers and tables utilized by the register renaming logic 46, and any registers (not shown) modified by the execution logic 50.

Although not illustrated in FIG. 10, a processing element can include other elements on chip with the processor core 40. For example, a processing element can include memory control logic along with the processor core 40. The processing element can include I/O control logic and/or can include I/O control logic integrated with memory control logic. The processing element can also include one or more caches.

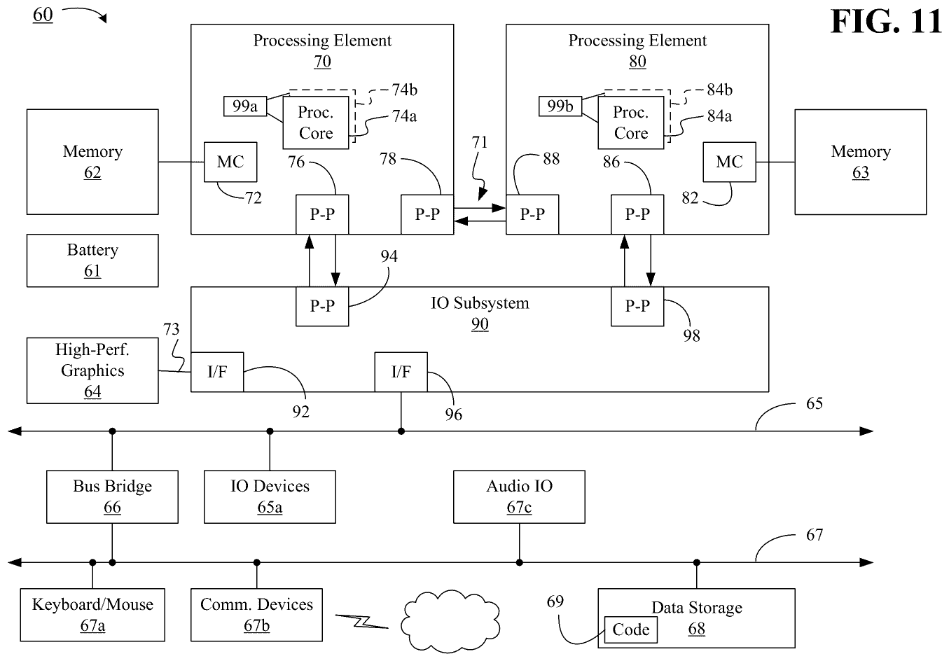

FIG. 11 is a block diagram illustrating an example of a multi-processor based computing system 60 according to one or more embodiments, with reference to components and features described herein including but not limited to the figures and associated description. The multiprocessor system 60 includes a first processing element 70 and a second processing element 80. While two processing elements 70 and 80 are shown, it is to be understood that an embodiment of the system 60 can also include only one such processing element.

The system 60 is illustrated as a point-to-point interconnect system, wherein the first processing element 70 and the second processing element 80 are coupled via a point-to-point interconnect 71. It should be understood that any or all of the interconnects illustrated in FIG. 11 can be implemented as a multi-drop bus rather than point-to-point interconnect.

As shown in FIG. 11, each of the processing elements 70 and 80 can be multicore processors, including first and second processor cores (i.e., processor cores 74a and 74b and processor cores 84a and 84b). Such cores 74a, 74b, 84a, 84b can be configured to execute instruction code in a manner similar to that discussed above in connection with FIG. 10.

Each processing element 70, 80 can include at least one shared cache 99a, 99b. The shared cache 99a, 99b can store data (e.g., instructions) that are utilized by one or more components of the processor, such as the cores 74a, 74b and 84a, 84b, respectively. For example, the shared cache 99a, 99b can locally cache data stored in a memory 62, 63 for faster access by components of the processor. In one or more embodiments, the shared cache 99a, 99b can include one or more mid-level caches, such as level 2 (L2), level 3 (L3), level 4 (L4), or other levels of cache, a last level cache (LLC), and/or combinations thereof.

While shown with only two processing elements 70, 80, it is to be understood that the scope of the embodiments is not so limited. In other embodiments, one or more additional processing elements can be present in a given processor. Alternatively, one or more of the processing elements 70, 80 can be an element other than a processor, such as an accelerator or a field programmable gate array. For example, additional processing element(s) can include additional processors(s) that are the same as a first processor 70, additional processor(s) that are heterogeneous or asymmetric to processor a first processor 70, accelerators (such as, e.g., graphics accelerators or digital signal processing (DSP) units), field programmable gate arrays, or any other processing element. There can be a variety of differences between the processing elements 70, 80 in terms of a spectrum of metrics of merit including architectural, micro architectural, thermal, power consumption characteristics, and the like. These differences can effectively manifest themselves as asymmetry and heterogeneity amongst the processing elements 70, 80. For at least one embodiment, the various processing elements 70, 80 can reside in the same die package.

The first processing element 70 can further include memory controller logic (MC) 72 and point-to-point (P-P) interfaces 76 and 78. Similarly, the second processing element 80 can include a MC 82 and P-P interfaces 86 and 88. As shown in FIG. 11, MC's 72 and 82 couple the processors to respective memories, namely a memory 62 and a memory 63, which can be portions of main memory locally attached to the respective processors. While the MC 72 and 82 is illustrated as integrated into the processing elements 70, 80, for alternative embodiments the MC logic can be discrete logic outside the processing elements 70, 80 rather than integrated therein.

The first processing element 70 and the second processing element 80 can be coupled to an I/O subsystem 90 via P-P interconnects 76 and 86, respectively. As shown in FIG. 11, the I/O subsystem 90 includes P-P interfaces 94 and 98. Furthermore, the I/O subsystem 90 includes an interface 92 to couple I/O subsystem 90 with a high performance graphics engine 64. In one embodiment, a bus 73 can be used to couple the graphics engine 64 to the I/O subsystem 90. Alternately, a point-to-point interconnect can couple these components.

In turn, the I/O subsystem 90 can be coupled to a first bus 65 via an interface 96. In one embodiment, the first bus 65 can be a Peripheral Component Interconnect (PCI) bus, or a bus such as a PCI Express bus or another third generation I/O interconnect bus, although the scope of the embodiments are not so limited.

As shown in FIG. 11, various I/O devices 65a (e.g., biometric scanners, speakers, cameras, and/or sensors) can be coupled to the first bus 65, along with a bus bridge 66 which can couple the first bus 65 to a second bus 67. In one embodiment, the second bus 67 can be a low pin count (LPC) bus. Various devices can be coupled to the second bus 67 including, for example, a keyboard/mouse 67a, communication device(s) 67b, and a data storage unit 68 such as a disk drive or other mass storage device which can include code 69, in one embodiment. The illustrated code 69 can implement one or more aspects of the processes described above, including the process 600 and/or the process 700. The illustrated code 69 can be similar to the code 42 (FIG. 10), already discussed. Further, an audio I/O 67c can be coupled to second bus 67 and a battery 61 can supply power to the computing system 60. The system 60 can implement one or more aspects of the socket 100, the system 150, the slice 200, the compute tile 300, the amorphous core engine 400, and/or the pipeline 450 as described herein with reference to FIGS. 1A-1B, 2, 3, 4A-4B, and 5A-5D.

Note that other embodiments are contemplated. For example, instead of the point-to-point architecture of FIG. 11, a system can implement a multi-drop bus or another such communication topology. Also, the elements of FIG. 11 can alternatively be partitioned using more or fewer integrated chips than shown in FIG. 11.

Embodiments of each of the above systems, devices, components, features and/or methods, including the socket 100, the compute tile 110, the reconfigurable core 112, the system 150, the slice 200, the compute tile 300, the amorphous core engine 400, the pipeline 450, the method 600, and/or the method 700, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, RISC processors and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

Alternatively, or additionally, all or portions of the foregoing systems, devices, components, features and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as Java, JavaScript, Python, C #, C++, Perl, Smalltalk, or the like and conventional procedural programming languages, such as the “C” programming language or similar programming languages.

### Additional Notes and Examples

Example A1 includes a semiconductor apparatus, comprising a plurality of pipelines comprising a core, wherein the core is reconfigurable into one of a plurality of core modes, a core network to provide inter-pipeline connections for the plurality of pipelines, one or more substrates, and logic coupled to the plurality of pipelines and the one or more substrates, wherein the logic is implemented at least partly in one or more of configurable logic or fixed-functionality hardware logic, the logic to receive a morph instruction including a target core mode from an application running on the core, determine a present core state for the core, and morph, based on the present core state, the core to the target core mode.

Example A2 includes the semiconductor apparatus of Example A1, wherein to morph the core, the logic is to select, based on the target core mode, which inter-pipeline connections are active.

Example A3 includes the semiconductor apparatus of Example A1 or A2, wherein each pipeline of the plurality of pipelines includes at least one multiplexor via which one or more of the inter-pipeline connections are selected to be active.

Example A4 includes the semiconductor apparatus of any of Examples A1-A3, further comprising a morphing bus connected to each of the plurality of pipelines to provide mode select bits.

Example A5 includes the semiconductor apparatus of any of Examples A1-A4, wherein to morph the core, the logic is further to select, based on the target core mode, which memory access paths are active.

Example A6 includes the semiconductor apparatus of any of Examples A1-A5, wherein the plurality of core modes include a default mode and one or more of a single instruction multiple data (SIMD) mode, a multiple instruction multiple data (MIMD) mode, or a tensor mode.

Example A7 includes the semiconductor apparatus of any of Examples A1-A6, wherein the default mode is a superscalar mode.

Example A8 includes the semiconductor apparatus of any of Examples A1-A7, wherein the present core state includes a current core mode and an identification of currently active pipelines, and wherein to morph the core comprises to determine that the current core mode is the default mode, the target mode is a mode other than the default mode, and there are no currently active pipelines.

Example A9 includes the semiconductor apparatus of any of Examples A1-A8, wherein the logic is further to morph the core to the default mode when all hardware threads for the current core mode have issued an unmorph instruction.

Example S1 includes a performance-enhanced computing system comprising a memory, and a plurality of cores arranged in a first socket, the first socket coupled to the memory, wherein each core of the plurality of cores comprises a plurality of pipelines, wherein the core is reconfigurable into one of a plurality of core modes, a core network to provide inter-pipeline connections for the plurality of pipelines, and logic coupled to the plurality of pipelines, wherein the logic is implemented at least partly in one or more of configurable logic or fixed-functionality hardware logic, the logic to receive a morph instruction including a target core mode from an application running on the core, determine a present core state for the core, and morph, based on the present core state, the core to the target core mode.

Example S2 includes the system of Example S1, wherein to morph the core, the logic is to select, based on the target core mode, which inter-pipeline connections are active.

Example S3 includes the system of Example S1 or S2, wherein each pipeline of the plurality of pipelines includes at least one multiplexor via which one or more of the inter-pipeline connections are selected to be active.

Example S4 includes the system of any of Examples S1-S3, wherein each core further comprises a morphing bus connected to each of the plurality of pipelines to provide mode select bits.

Example S5 includes the system of any of Examples S1-S4, wherein to morph the core, the logic is further to select, based on the target core mode, which memory access paths are active.

Example S6 includes the system of any of Examples S1-S5, wherein the plurality of core modes include a default mode and one or more of a single instruction multiple data (SIMD) mode, a multiple instruction multiple data (MIMD) mode, or a tensor mode.

Example S7 includes the system of any of Examples S1-S6, wherein the default mode is a superscalar mode.

Example S8 includes the system of any of Examples S1-S7, wherein the present core state includes a current core mode and an identification of currently active pipelines, and wherein to morph the core comprises to determine that the current core mode is the default mode, the target mode is a mode other than the default mode, and there are no currently active pipelines.

Example S9 includes the system of any of Examples S1-S8, wherein the logic is further to morph the core to the default mode when all hardware threads for the current core mode have issued an unmorph instruction.

Example S10 includes the system of any of Examples S1-S9, further comprising at least one additional socket coupled to the first socket and the memory.

Example S11 includes the system of any of Examples S1-S10, further comprising a host processor coupled to the first socket and the at least one additional socket via a network.

Example M1 includes a method comprising issuing a first morph instruction including a first target core mode to a core, wherein the core is reconfigurable into one of a plurality of core modes, and wherein responsive to the first morph instruction the core is morphed into the first target core mode, performing a first set of compute tasks via the core in the first target core mode, issuing a second morph instruction including a second target core mode to the core, wherein responsive to the second morph instruction the core is morphed into the second target core mode, performing a second set of compute tasks via the core in the second target core mode.

Example M2 includes the method of Example M1, wherein the plurality of core modes include a default mode and one or more of a single instruction multiple data (SIMD) mode, a multiple instruction multiple data (MIMD) mode, or a tensor mode.

Example M3 includes the method of Example M1 or M2, wherein the first target core mode is the MIMD mode, and wherein the first set of compute tasks include tasks directed to sparse data operations.

Example M4 includes the method of any of Examples M1-M3, wherein the first target core mode is the SIMD mode, and wherein the first set of compute tasks include vector operations.

Example M5 includes the method of any of Examples M1-M4, wherein the first target core mode is the tensor mode, and wherein the first set of compute tasks include one or more of matrix multiplication operations or convolution operations.

Example M6 includes the method of any of Examples M1-M5, wherein the core is morphed to the default mode after the first set of compute tasks is completed and before the core is morphed into the second core mode.

Example M7 includes the method of any of Examples M1-M6, further comprising issuing an unmorph instruction to morph the core to the default mode prior to issuing the second morph instruction.

Example R1 includes an apparatus comprising means for performing the method of any of Examples M1 to M7.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), solid state drive (SSD)/NAND drive controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus, comprising:
a plurality of pipelines comprising a core, wherein the core is reconfigurable into one of a plurality of core modes;
a core network to provide inter-pipeline connections for the plurality of pipelines;
one or more substrates; and
logic coupled to the plurality of pipelines and the one or more substrates, wherein the logic is implemented at least partly in one or more of configurable logic or fixed-functionality hardware logic, the logic to:
receive a morph instruction including a target core mode from an application running on the core;
determine a present core state for the core; and
morph, based on the present core state, the core to the target core mode.

2. The semiconductor apparatus of claim 1, wherein to morph the core, the logic is to select, based on the target core mode, which inter-pipeline connections are active.

3. The semiconductor apparatus of claim 2, wherein each pipeline of the plurality of pipelines includes at least one multiplexor via which one or more of the inter-pipeline connections are selected to be active.

4. The semiconductor apparatus of claim 3, further comprising a morphing bus connected to each of the plurality of pipelines to provide mode select bits.

5. The semiconductor apparatus of claim 2, wherein to morph the core, the logic is further to select, based on the target core mode, which memory access paths are active.

6. The semiconductor apparatus of claim 1, wherein the plurality of core modes include a default mode and one or more of a single instruction multiple data (SIMD) mode, a multiple instruction multiple data (MIMD) mode, or a tensor mode.

7. The semiconductor apparatus of claim 6, wherein the present core state includes a current core mode and an identification of currently active pipelines, wherein to morph the core comprises to determine that the current core mode is the default mode, the target mode is a mode other than the default mode, and there are no currently active pipelines, and wherein the logic is further to morph the core to the default mode when all hardware threads for the current core mode have issued an unmorph instruction.

8. A performance-enhanced computing system comprising:
a memory; and
a plurality of cores arranged in a first socket, the first socket coupled to the memory, wherein each core of the plurality of cores comprises:
a plurality of pipelines, wherein the core is reconfigurable into one of a plurality of core modes;
a core network to provide inter-pipeline connections for the plurality of pipelines; and
logic coupled to the plurality of pipelines, wherein the logic is implemented at least partly in one or more of configurable logic or fixed-functionality hardware logic, the logic to:
receive a morph instruction including a target core mode from an application running on the core;
determine a present core state for the core; and
morph, based on the present core state, the core to the target core mode.

9. The system of claim 8, wherein to morph the core, the logic is to select, based on the target core mode, which inter-pipeline connections are active.

10. The system of claim 9, wherein each pipeline of the plurality of pipelines includes at least one multiplexor via which one or more of the inter-pipeline connections are selected to be active.

11. The system of claim 10, wherein each core further comprises a morphing bus connected to each of the plurality of pipelines to provide mode select bits.

12. The system of claim 9, wherein to morph the core, the logic is further to select, based on the target core mode, which memory access paths are active.

13. The system of claim 8, wherein the plurality of core modes include a default mode and one or more of a single instruction multiple data (SIMD) mode, a multiple instruction multiple data (MIMD) mode, or a tensor mode.

14. The system of claim 13, wherein the present core state includes a current core mode and an identification of currently active pipelines, wherein to morph the core comprises to determine that the current core mode is the default mode, the target mode is a mode other than the default mode, and there are no currently active pipelines, and wherein the logic is further to morph the core to the default mode when all hardware threads for the current core mode have issued an unmorph instruction.

15. The system of claim 8, further comprising:
at least one additional socket coupled to the first socket and the memory; and
a host processor coupled to the first socket and the at least one additional socket via a network.

16. A method comprising:
issuing a first morph instruction including a first target core mode to a core, wherein the core is reconfigurable into one of a plurality of core modes, and wherein responsive to the first morph instruction the core is morphed into the first target core mode;
performing a first set of compute tasks via the core in the first target core mode;
issuing a second morph instruction including a second target core mode to the core, wherein responsive to the second morph instruction the core is morphed into the second target core mode;
performing a second set of compute tasks via the core in the second target core mode.

17. The method of claim 16, wherein the plurality of core modes include a default mode and one or more of a single instruction multiple data (SIMD) mode, a multiple instruction multiple data (MIMD) mode, or a tensor mode.

18. The method of claim 17, wherein when the first target core mode is the MIMD mode, the first set of compute tasks include tasks directed to sparse data operations, wherein when the first target core mode is the SIMD mode, the first set of compute tasks include vector operations, and wherein when the first target core mode is the tensor mode, the first set of compute tasks include one or more of matrix multiplication operations or convolution operations.

19. The method of claim 17, wherein the core is morphed to the default mode after the first set of compute tasks is completed and before the core is morphed into the second core mode.

20. The method of claim 19, further comprising issuing an unmorph instruction to morph the core to the default mode prior to issuing the second morph instruction.
